(19) United States
(12) Patent Application Publication
(10) Pub. No.: US 2023/0083202 A1
(43) Pub. Date: Mar. 16, 2023

(54) Removal of Crude Oil from Water in a Gas Oil Separation Plant (GOSP)

(71) Applicant: Saudi Arabian Oil Company, Dhahran (SA)

(72) Inventor: Nagoorpitchai S. Meeranpillai, Al Khobar (SA)

(21) Appl. No.: 17/476,194

(22) Filed: Sep. 15, 2021

(51) Int. Cl. E21B 43/40; C02F 1/40

(52) U.S. Cl. CPC E21B 43/40; C02F 1/40; B01D 17/047

(57) ABSTRACT

A system and method for a gas oil separation plant (GOSP) that receives crude oil from a wellhead. The GOSP has a sand filter associated with a water-oil separator vessel that removes crude oil from oily water in the GOSP. The sand filter is a filter having sand as filter media.

### TECHNICAL FIELD

This disclosure relates to removal of crude oil from oily water in a gas oil separation plant (GOSP).

### BACKGROUND

A gas oil separation plant (GOSP) may process crude oil received via a wellhead from a hydrocarbon-bearing reservoir in a subterranean formation. The GOSP may have a train of vessels that operate at sequentially lower pressure to remove volatile gases, water, and salt from the crude oil. The GOSP may discharge the processed crude oil as export crude oil (product crude oil) for distribution including to storage and transportation for further processing, such as in a petroleum refinery. A stabilizer distillation column associated with (or integrated with) the GOSP may remove gases from the crude oil to lower vapor pressure of the crude oil to stabilize the crude oil. The stabilizer distillation column may remove hydrogen sulfide (if present) from the crude oil to sweeten the crude oil.

The crude oil received at the GOSP from the wellhead typically includes produced water. The produced water may be dispersed as water droplets in a continuous phase of the crude oil. Thus, the crude oil received at the GOSP may be an emulsion (an oil-water emulsion). The crude oil may be a tight emulsion of oil and water.

### SUMMARY

An aspect relates to a method of operating a gas oil separation plant (GOSP), the method including receiving crude oil from a wellhead. The method includes removing gas, water, and salt from the crude oil via a GOSP train having a first production trap, a second production trap, a dehydrator vessel, and a desalter vessel. The method includes discharging oily water from the GOSP train to a water-oil separator vessel, the oily water including water and crude oil. The method includes separating the crude oil from the oily water via a weir in the water-oil separator vessel to give first water (intermediate water). The method includes discharging the first water from the water-oil separator vessel through a sand filter, thereby removing crude oil from the first water via the sand filter to give second water (e.g., for injection disposal). The sand filter is a filter having sand as filter media.

Another aspect relates to a method of retrofitting a GOSP. The method includes identifying that water discharged from a water-oil separator vessel in the GOSP has a concentration of crude oil exceeding a specified value, wherein the water-oil separator vessel removes crude oil from oily water to give the water. The water-oil separator vessel in operation receives the oily water from a GOSP train of the GOSP. The GOSP train includes a first production trap, a second production trap, a dehydrator vessel, and a desalter vessel, wherein the GOSP train in operation removes gas, water, and salt from crude oil received from a wellhead. The method includes installing a sand filter at a water outlet of the water-oil separator vessel. The sand filter is a filter having sand as filter media. The method includes installing a backwashing water pump. The method includes installing a backwashing water conduit to supply backwashing water from the backwashing water pump to the sand filter.

Yet another aspect relates to a GOSP. The GOSP includes a first production trap to receive crude oil from a wellhead and remove gas and water from the crude oil, the first production trap having an outlet to discharge first oily water to a water-oil separator vessel. The GOSP includes a second production trap to receive the crude oil from the first production trap and remove gas from the crude oil. The GOSP includes a dehydrator vessel to receive the crude oil from the second production trap and remove water from the crude oil, the dehydrator vessel having an outlet to discharge second oily water to the water-oil separator vessel. The GOSP includes the water-oil separator vessel to remove crude oil from oily water (including the first oily water and the second oily water) to discharge crude oil and discharge intermediate water. The GOSP includes a sand filter disposed at an outlet of the water-oil separator vessel to remove crude oil from the intermediate water and discharge water (e.g., for injection disposal), wherein the sand filter is a filter having sand as filter media.

The details of one or more implementations are set forth in the accompanying drawings and the description below. Other features and advantages will be apparent from the description and drawings, and from the claims.

### BRIEF DESCRIPTION OF DRAWINGS

FIG. 1 is a block flow diagram of a gas oil separation plant (GOSP) that processes crude oil received from wellheads and discharges export crude oil as product, and includes a water-separation (WOSEP) vessel system to separate crude oil from oily water.

FIG. 2 is a diagram of a WOSEP vessel system having a WOSEP vessel and a sand filter disposed at the water outlet of the WOSEP vessel.

FIG. 2A is an image (perspective view) of an example of a conduit portion that may be labeled as a spool piece.

FIG. 3 is a diagram a WOSEP vessel system that is similar to the WOSEP vessel system of FIG. 2, except that the sand filter is a standalone filter instead of with the sand (filter media) disposed in the water outlet nozzle of the WOSEP vessel or in the water discharge conduit coupled to the water outlet nozzle.

FIG. 4 is a diagram of a WOSEP vessel system that is similar to the WOSEP vessel system of FIG. 2, except that the internal separator in the WOSEP vessel is depicted in particular as a weir or weir arrangement.

FIG. 5 is a diagram of a WOSEP vessel having two outlet nozzles for discharging water.

FIG. 6 is a diagram of a WOSEP vessel having internal coalescer filters, and an outlet nozzle for discharging water.

FIG. 7 is a block flow diagram of a method of operating a GOSP.

FIG. 8 is a block flow diagram of a method of retrofitting a GOSP.

FIG. 9 is an image of a beaker having the emulsion of water (about 96 vol %) and crude oil (about 4 vol %) utilized in the Example.

FIG. 10 is an image depicting the filtration (via a separating funnel with sand) performed in the experiment procedure in the Example.

FIG. 11 is an image of two test tubes from the first experiment in the Example.

FIG. 12 is an image of two test tubes from the second experiment in the Example.

Like reference numbers and designations in the various drawings indicate like elements.

### DETAILED DESCRIPTION

The crude oil received at a gas oil separation plant (GOSP) for processing from the wellhead typically includes produced water that was produced along with the crude oil from the subterranean formation. Thus, the crude oil received at the GOSP may be an emulsion of crude oil and water. The water may be primarily (or all) produced water. A train of vessels in the GOSP may remove the water and gas from the crude oil. The removed water may have entrained crude oil and thus be labeled as oily water. The oily water may be sent to a water-oil separator (WOSEP) vessel that removes crude oil from the oily water to give the water as cleaned water, e.g., for disposal. In some instances, this cleaned water as disposal water may be injected into a subterranean formation. As for the removed crude oil, the WOSEP vessel may discharge the removed crude oil for recovery.

Aspects of the present disclosure are directed to configuration and operation of a WOSEP vessel that removes crude oil from oily water in a GOSP. The techniques may relate to employing sand as filter media at or near the water outlet of the WOSEP vessel to further remove crude oil from the oily water. The filter with sand as filter media may remove crude oil (and solids) that remain in the water discharged from the WOSP vessel. The crude oil removed by the sand filter may collect on the sand (filter media). In some instances, the crude oil may deposit on (adhere to) the sand particles. The filter media (sand) may occasionally be subjected to a backflush (e.g., with utility water) to clean the filter media. Bench scale testing in the laboratory confirmed that naturally available quartz sand (silica) as filter media can remove crude oil from water having 4 volume percent (vol %) crude oil to give the water having 99.9+ vol % purity.

The sand filter may be an inline filter disposed in the water outlet nozzle of the WOSEP vessel or in discharge piping coupled to the water discharge nozzle of the WOSEP vessel, or both.

In other implementations, the sand filter may be a standalone filter. In particular, the sand filter may be a vessel (other than the WOSEP vessel water outlet nozzle or discharge piping) with the sand (filter media) therein and be disposed along the water discharge piping from the WOSEP vessel. For the sand filter as a standalone filter having the vessel (e.g., as filter housing), the sand filter may be a skid-mounted unit is some implementations.

The sand filter may be labeled as a final removal filter, finishing filter, polishing filter, tapering filter, and the like, in removing remaining or residual crude oil (not removed by the WOSEP vessel) from the water discharged from the WOSEP vessel. In implementations, the sand filter can be consider part of (a component of) the WOSEP vessel system.

The GOSP can be configured for both the WOSEP vessel and the sand filter to each contribute significantly to removal of crude oil from the oily water in normal operation. On the other hand, the GOSP can be configured such that the sand filter contributes to significant removal of the crude oil not during normal operation but instead during abnormal operation, such as an upset condition when the WOSEP vessel discharges water with greater content of crude oil than typical.

The sand filter may be installed as part of grassroots construction of the GOSP facility. In other words, the sand filter may be associated with the WOSEP vessel contemporaneous with construction of the GOSP including installation of the WOSEP vessel.

The sand filter may be installed as a retrofit of an existing GOSP. In some instances, the water cut (amount of produced water) in the crude oil produced from the subterranean formation via the wellhead to the GOSP may increase over the years. Therefore, the amount of oily water sent to the WOSEP vessel from the GOSP train may increase. Such may overburden the WOSEP vessel and thus the amount of crude oil in the water discharged from the WOSEP vessel may increase. In a retrofit or modification of the GOSP facility, the sand filter may be installed at or near the WOSEP vessel water outlet to remove the increased content of crude oil in the water discharged from the WOSEP vessel.

The present disclosure may relate to application of sand (e.g., as a natural material) for removal of crude oil from oily water. The crude oil may be emulsified in the oily water as received at the WOSEP vessel. As discussed, the water may be or include produced water received at the GOSP from the wellhead. In operation, the WOSEP vessel removes crude oil from the oily water, such as via an internal weir. The sand filter removes remaining crude oil from the oily water to give cleaned water, e.g., as disposal water. The sand filter may be associated with the WOSEP vessel.

Embodiments may be a modified process to increase removal of impurities presence in the produced water discharged from WOSEP vessel. A function of a WOSEP vessel in the GOSP may be to remove crude oil dispersed (e.g., emulsified) in the produced water and remove solids (impurities) present in the produced water. Due to the increasing water-cuts in the wet-producers, the oil removal efficiency of the WOSEP vessel can be decreased. In other words, with more water entering the GOSP from the wellhead, a greater flow rate of oily water may be provided from the GOSP train to the WOSEP vessel and therefore the WOSEP vessel separation efficiency may suffer. The excess impurities (including crude oil) in the water (disposal water) discharged from the WOSEP vessel may cause injectivity problems at disposal wells. An injectivity issue or problem caused by high content of crude oil in the disposal water may be, for example, injection-well resistance to injection of the water due to presence of accumulated crude oil in the injection well.

In certain implementations, the techniques may employ naturally available sand (e.g., quartz sand that is silica saturated), which may be relatively inexpensive and readily available, as filter media on the WOSEP vessel water outlet. The sand as filter media can be cleaned (e.g., after a time of use) with utility water by backflush.

As presented in the Example below, two identical laboratory experiments that evaluated silica-based material as filter media showed that the silica material is effective in removing oily impurities from produced water.

The sand filter may increase efficiency of the WOSEP vessel system and reduce occurrence of injection problems at the water disposal well(s) that dispose of the water discharged from the WOSEP vessel or WOSEP vessel system. As discussed, embodiments may increase disposal water quality and recover emulsified crude by filtration with sand. The techniques may include the sand filter in the WOSEP vessel system to increase quality (purity) of disposal water and avoid well injectivity problem(s).

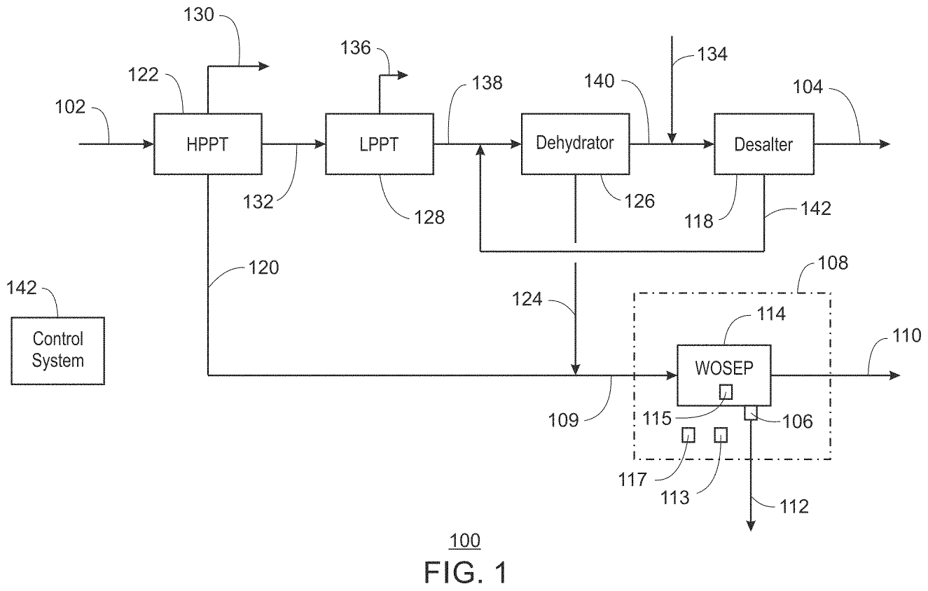

FIG. 1 is a GOSP 100 that processes crude oil 102 (having water, such as produced water) received from a wellhead and discharges export crude oil 104 as product. The GOSP 100 removes water, gas, and salt from the crude oil 102 to give the export crude oil 104. The GOSP 100 includes a sand filter 106, as discussed below.

The GOSP has a WOSEP vessel system 108 that processes oily water 109. The oily water 109 may be water (e.g., produced water) as a continuous phase having crude oil dispersed in the water. The crude oil in the oily water 109 may be, for example, at least 1 vol %, at least 3 vol %, at least 4 vol %, at least 5 vol %, at least 8 vol %, or at least 10 vol %, or in ranges of 1 vol % to 15 vol %, 5 vol % to 20 vol %, or 10 vol % to 20 vol %, and so on. In implementations, the oily water 109 has less than 20 vol % of crude oil, less than 15 vol % of crude oil, or less than 10 vol % of crude oil. In operation, the WOSP vessel system 108 removes crude oil 110 from the oily water 109 and discharges water 112. In implementations, the removed crude oil 110 may be recovered. In implementations, the discharged water 112 may be disposal water that, for example, is injected into a subterranean formation. The WOSEP vessel system 108 (or downstream system) may include an injection pump 113 (e.g., centrifugal pump) that injects the water 112 into the subterranean formation. In implementations, it may be desired that the water 112 have an oil content less than 100 parts per million by volume (ppmv).

The WOSEP vessel system 108 has a WOSEP vessel 114 and the sand filter 106. The sand filter 114 is a filter having sand (e.g., natural sand or quartz sand) as the filter media. The WOSEP vessel 114 may have an internal separator 115 (e.g., a weir arrangement) that separates the crude oil 110 from the oily water 109 and discharges an intermediate water (e.g., having crude oil in a range of 1 vol % to 10 vol %) through the sand filter 106. The intermediate water may be labeled as first water. The sand filter 106 removes crude oil from the intermediate water to give the water 112 (e.g., disposal water, relatively clean water, recovered water, sewer water, injection water, etc.) having, for example, less than 1 vol % of crude oil, less than 0.1 vol % of crude oil, or less than 0.01 vol % of crude oil. The water 112 may be labeled as second water.

The crude oil removed by the sand filter 106 is collected on the sand. The WOSEP vessel system 108 may include a backwashing pump 117 (e.g., centrifugal pump) to provide water (e.g., utility water or plant water) and/or other fluid as backwashing fluid to backwash the sand filter 106 to clean the sand filter 106.

The feed crude oil 102 received at the GOSP 100 from a well may be as produced from a subterranean formation through a wellbore (and production manifold) to the GOSP 100. The feed crude oil 102 may flow through a production manifold associated with one or more wellheads to the GOSP 100. The feed crude oil 102 may be from a well pool. As described, the feed crude oil 102 may include water and thus be labeled as wet crude oil. The feed crude oil 102 received at the GOSP 100 may be a tight emulsion of oil and water in some examples. A tight emulsion is generally an emulsion with small and closely distributed droplets.

As mentioned, the GOSP 100 removes gas, water, and salt from the crude oil 102. The GOSP 100 may remove hydrocarbons as gas from the crude oil via lowering pressure of the crude oil 102. The removed hydrocarbons may be light hydrocarbons (e.g., C1 to C4) and medium or heavier hydrocarbons (e.g., C5+).

In the illustrated implementation, the GOSP 100 includes a high-pressure production trap (HPPT) 122, a low-pressure production trap (LPPT) 128, dehydrator 126, and the desalter 118. The HPPT 122, LPPT 128, dehydrator 126, and desalter 118 may be characterized as components of a GOSP 100 train. The HPPT 122, LPPT 128, dehydrator 126, and desalter 118 are each a separator vessel known to one of ordinary skill in the art and that may have a horizontal orientation or vertical orientation. In embodiments, the HPPT 122, LPPT 128, dehydrator 126, and desalter 118 are all horizontal vessels. In certain examples, the HPPT 122 vessel, LPPT 128 vessel, dehydrator 126 vessel, and desalter 118 vessel each have elliptical-type heads.

The HPPT 122 vessel, LPPT 128 vessel, dehydrator 126 vessel, and desalter 118 vessel generally include nozzles (e.g., flanged, screwed connections, etc.) on the vessel body or heads to couple to conduits for receiving and discharging streams. An inlet on the vessel may be a nozzle that couples to a feed or supply conduit to the vessel. An outlet on the vessel may be a nozzle that couples to a discharge conduit from the vessel. Nozzles on the vessels may also be employed for instrumentation (e.g., sensors, gauges, transmitters, etc.) and other uses.

In operation, the HPPT 122 may receive the feed crude oil 102 via a conduit. The HPPT 122 as a separation vessel may provide for a three-phase separation. In particular, the HPPT 122 separates gas 130 and water 120 from the feed crude oil 102 and discharges crude oil 132. This HPPT water 120 discharge stream is generally not oily due to the fact that there is typically a constant water level in the HPPT 122, which generally maintains the oil droplets at the interface, not in the bulk. The HPPT 122 vessel may include an inlet separation device to promote separation of the gas 130 and water 120 from the feed crude oil 120. The inlet separation device may promote an initial gross separation by changing the flow direction of the feed crude oil 102 entering the HPPT 122 vessel. The inlet separation device may be, for example, an inlet diverter. The inlet diverter can be a splash plate, inlet deflector, deflector baffle, or baffle plate(s). The inlet diverter as a baffle plate can be a spherical dish, flat plate, angle iron, or another type of structural steel. The inlet diverted can be a half sphere, cone, or centrifugal diverter, and so on.

The HPPT 122 as a three-phase separator vessel may utilize gravity or density difference to separate the water 120 from the crude oil 132. For instance, the HPPT 122 vessel may include a weir to facilitate the separation in which the oil (the lighter of the two liquids) overflows the weir. The water 120 may generally discharge from within the weir. The separated water 120 (e.g., as oily water) may be sent, for example, to the WOSEP vessel 114. The oily water 109 received at the WOSP vessel system 109 may include the separated water 120. In implementations, the operating pressure in the HPPT 122 may be at least 150 pounds per square inch gauge (psig). The operating temperature in the HPPT 122 may be, for example, at least about 65° F., or in a range of 65° F. to 150° F.

The separated gas 130 that discharges from the HPPT 122 may generally be light hydrocarbons. The feed crude oil 102 is reduced in pressure in the HPPT 122 to separate the gas 130. In embodiments, the gas 130 may be light hydrocarbons (C1-C4) having a number of carbons in the range 1 to 4 and trace amount of C5+ hydrocarbons having five or more carbons. In implementations, the gas 130 as a light (or lighter) hydrocarbon stream may generally be C1-C4 components (e.g., methane, ethane, propane, butane, isobutane) and trace amounts of C5+ compounds. The pressure of the gas 130 as discharged may range in pressure, for example, from 150 psig to 450 psig depending, for instance, on the supply pressure of the feed crude oil 102. The gas 130 can include lighter hydrocarbons, traces of C5+ hydrocarbons, hydrogen sulfide (H₂S), carbon dioxide (CO₂), nitrogen (N₂), and water vapor. The relative amounts and types of compounds in the gas 130 may typically depend on composition of the feed crude oil 102 and the flash pressure in the HPPT 122. The separated gas 130 may be sent to a mechanical compressor or to a gas plant for recovery.

The crude oil 132 is discharged from the HPPT 122 via a conduit to the LPPT 128. The motive force for flow of the crude oil 132 may be pressure differential. The LPPT 128 operates at a lower pressure than the HPPT 122. In implementations, the operating pressure in the LPPT 128 may be less than 50 psig. The operating temperature of the LPPT 128 may be, for example, at least about 65° F., or in a range of 65° F. to 150° F. The LPPT 128 vessel may include an inlet diverter to promote an initial gross separation of gas 136 from the crude oil 132 by changing the flow direction of the entering crude oil 132.

The LPPT 128 may be characterized as a two-phase separation vessel or three-phase separation vessel. The LPPT 128 separates gas 136 (e.g., certain remaining off-gases) from the crude oil 132 and discharges a crude oil 138 stream. The gas 136 may typically be heavier hydrocarbons. The medium or heavy hydrocarbon stream as the gas 136 may refer generally to C5+(five-carbon and greater) hydrocarbons (e.g., pentane, isopentane, hexane, and heptane) and trace amounts of lighter hydrocarbons and other light components. In certain examples, the gas 136 may discharge at a pressure of, at least 50 psig, or in a range of 40 psig to 60 psig. The gas 136 may be sent to a mechanical compressor or gas compression plant for recovery.

The crude oil 138 discharged from the LPPT 128 may be labeled as de-gassed and de-watered crude oil. The crude oil 138 may be sent to the dehydrator 126. In implementations, the crude oil may be pumped from the LPPT 128 to the dehydrator 126 via a pump (not shown). The pump may be, for example, a centrifugal pump or positive displacement pump. In certain implementations, the crude oil 138 may flow through a heat exchanger (not shown) to heat the crude oil 138. The heat exchanger may be, for example, a shell-and-tube heat exchanger, a plate-and-frame heat exchanger, etc. In operation, the pump head provides motive force for flow of the crude oil 138 through the heat exchanger to the dehydrator 126. The heat exchanger heats the crude oil 138 to advance downstream separation of water and salt from the crude oil. This increase in temperature of the crude oil 138 may promote coalescence and settling of water droplets from the crude oil in downstream processing. The heat transfer fluid for the heat exchanger may be, for example, steam or steam condensate, or a process stream (e.g., crude oil). The crude oil 138 may be heated in the heat exchanger via cross-exchange with other crude oil to recover heat from the other crude oil. In some embodiments, a low-pressure degassing tank (LPDT) (not shown) may be operationally disposed between the LPPT 128 and the dehydrator 126, such as between the heat exchanger (if employed) and the dehydrator 126. An LPDT may be employed, for example, in cases of the system 100 that will flash the crude oil in a stabilizing distillation column downstream of the desalter 118.

In the dehydrator 126 vessel, water 124 is separated from the crude oil 138. Salt may discharge in the water 124 and thus be removed from the crude oil 140. Electrostatic coalescence may be employed in the dehydrator 126. In implementations, an electrostatic field is generated between electrodes in the dehydrator 126 vessel. Electrostatic coalescence applies an electric current, causing water droplets in the crude oil (emulsion) to collide, coalesce into larger (heavier) drops, and settle out of the crude oil as separate liquid water. This process partially dries wet crude oil. In one example, operating conditions of a dehydrator 126 unit include temperature in a range of 70° F. to 160° F., and a pressure at about 25 psig above the crude oil 140 vapor pressure. In some examples, fresh or recycle wash water (e.g., relatively low in salt) and/or chemicals may be injected into the dehydrator 126 vessel to advance separation of the water 124 from the crude oil 138. The separated water 124 discharged from the dehydrator 126 may be oily water (e.g., having salt) and sent to the WOSEP vessel 114. The oily water 109 received at the WOSEP vessel system 108 may include the water 124. In examples, oily water may have less than 20 vol % oil. The dehydrator 126 vessel may discharge crude oil 140 via a conduit to the desalter 118 vessel. The crude oil 140 may be labeled as dehydrated crude oil with some salt removed in implementations.

The salt removal in the GOSP 100 can be multi-stage. Both the desalter 118 and the dehydrator 126 may provide for salt removal. Thus, the embodiment of FIG. 1 may be two-stage desalting (salt removal). Moreover, in some examples, the desalter 118 can be two or more desalter vessels in series.

In the illustrated example, a single desalter 118 vessel is depicted. Water 142 having salt discharges from the desalter 118 and may be recycled to the dehydrator 126. Wash water 134 (e.g., fresh water) may be added to the desalter 118 vessel to facilitate removal of salt from the crude oil 140. Wash water 134 may be supplied to the desalter 118 to promote the separation generated by the electrostatic field in the desalter 118 vessel. The wash water 134 may be injected into the dehydrated crude oil 140 entering the desalter 118 to meet the salt content specification of the produced crude (export crude oil 104). The water 134 added may be low in salt concentration relative to the salt concentration of water (e.g., emulsified water) in the crude oil 140. Fresh wash water (as opposed, for example, to recycle water having more salt) may be utilized as the wash water 134 in the desalting process to increase the amount of salt rinsed from the crude oil 140. Wash water 134 salinity can range, for example, from between about 100 parts per million (ppm) to about 12,000 ppm. Again, wash water 134 may be more effective if the salinity level of the wash water 134 is low as with fresh water. In comparison, formation water salinity produced with crude oil can reach as high as about 270,000 ppm of salt or more.

The flowrate of the wash water 134 may be controlled via a flow control valve disposed along the conduit supplying the wash water 134. The valve opening (e.g., percent open) of the flow control valve may be adjusted by a flow controller (FC) to maintain flowrate of the wash water 134 per a flowrate set point of the flow controller for the control valve 134. The set point for the wash-water control valve may be manually set locally or manually entered into the control system 142. In addition to (or in lieu of) the flow control valve, flowrate of the wash water 134 may be controlled via the speed of the pump supplying the wash water 134. The pump may be, for example, a positive displacement pump or a centrifugal pump. The speed of the pump may be manually or automatically set and adjusted.

As in the upstream dehydrator 126, electrostatic coalescence may be employed in the desalter 118 vessel. Electrostatic coalescence may remove water emulsion from the crude oil 140. Operating conditions in the desalter 118 may be, for example, include a temperature in a range of 70° F. to 160° F. and an operating pressure at least 25 psig above vapor pressure of the crude oil 140. The wash water 134 may increase the water droplet concentration to enhance rupturing of the protective coating surrounding the brine and promote coalescence to form larger and more easily separated droplets to meet the crude salt content specification. Both the flowrate and quality (salinity) of wash water 134 may affect the crude desalting process. The desalter 118 may reduce the salt content of crude oil 140, for example, to less than 10 pounds of salt per thousand barrels (PTB) of oil.

The crude oil that discharges from the desalter 118 may be the export crude oil 104. The desalter 118 may discharge the export crude oil 104 for distribution including to storage and transportation, and for further processing such as in a petroleum refinery. The export crude oil 104 may be labeled as processed crude oil, product crude oil, stabilized crude oil, and so forth. The salt content of the export crude oil 104 may be monitored manually by periodically determining the salt content through laboratory analysis (e.g., once per 8-hour shift).

Specifications for the export crude oil 104 may include, for example: (1) salt content less than 10 PTB; (2) basic sediment and water (BS&W) content less than 0.2 volume percent (vol %) of the crude oil; (3) hydrogen sulfide (H₂S) content less than 70 ppm by weight (ppmw); and (4) maximum true vapor pressure (TVP) (per ASTM D 2879) less than 13 pounds per square inch absolute (psia) at storage temperature. The BS&W is generally measured from a liquid sample of the crude oil. The BS&W includes water, sediment, and emulsion. The BS&W is typically measured as a volume percentage of the crude oil. The BS&W specification may be less than 0.5 vol % for Heavy crude oil and less than 0.2 vol % for other crude oils.

In some examples, the desalter 118 may discharge the export crude oil 104 via a conduit to a stabilizer distillation column (not shown) that separates and removes light ends or light components (volatile components such as C1-C4 hydrocarbons) as gas from the export crude oil 104. These light components may discharge as an overhead stream from the stabilizer distillation column. This removal of the light components reduces vapor pressure of the export crude oil 104 to give a desired vapor pressure of the export crude oil 104 as stabilized crude oil. The associated specification of the export crude oil 104 may be, for example, Reid vapor pressure (RVP) or true vapor pressure (TVP), or both. The term “stabilized” may refer to the crude oil having a lower vapor pressure and thus being less volatile to facilitate tank storage and pipeline transport. The stabilization may be, for example, to lower the vapor pressure of the crude oil to at least 13 pounds per square inch (psi) below atmospheric pressure so that vapor will generally not flash under atmospheric conditions. The stabilizer distillation column may remove H₂S from the export crude oil 104 to sweeten the crude oil. The H₂S may discharge in the overhead stream in the light components. The terms “sweet” crude oil or to “sweeten” crude oil refers to lower H₂S content in the crude oil. In the stabilizer distillation column, any H₂S gas dissolved in the export crude oil 104 is removed to meet crude-oil specification of H₂S content, for example, less than 60 ppm, or in a range of 10 ppm to 70 ppm. If a stabilizer distillation column is employed, the stabilized export crude oil 104 may be discharged as the bottom streams from the stabilizer distillation column and pumped via the column bottoms pump to storage or distribution.

The GOSP 100 may include the control system 142 that facilitates or directs operation of the GOSP 100. For instance, the control system 142 may direct control of the supply or discharge of flow streams (including flowrate) and associated control valves, control of operating temperatures and operating pressures, and so on. The control system 142 may direct or be utilized to direct operation of the WOSEP vessel system 108.

The control system 142 may include a processor and memory storing code (e.g., logic, instructions, etc.) executed by the processor to perform calculations and direct operations of the GOSP 100. The processor (hardware processor) may be one or more processors and each processor may have one or more cores. The processor(s) may include a microprocessor, central processing unit (CPU), graphic processing unit (GPU), controller card, circuit board, or other circuitry. The memory may include volatile memory (for example, cache or random access memory), nonvolatile memory (for example, hard drive, solid-state drive, or read-only memory), and firmware. The control system 142 may include a desktop computer, laptop computer, computer server, control panels, programmable logic controller (PLC), distributed computing system (DSC), controllers, actuators, or control cards.

The control system 142 may be communicatively coupled to a remote computing system that performs calculations and provides direction. The control system 142 may receive user input or remote-computer input that specifies the set points of control devices or other control components in the GOSP 100. The control system 142 may employ local control panels distributed in the GOSP 100. Certain implementations may include a control room that can be a center of activity, facilitating monitoring and control of the GOSP 100 process or facility. The control room may contain a human machine interface (HMI), which is a computer, for example, that runs specialized software to provide a user-interface for the control system. The HMI may vary by vendor and present the user with a graphical version of the remote process. There may be multiple HMI consoles or workstations, with varying degrees of access to data.

The function of the WOSEP vessel 114 or WOSEP vessel system 108 may be to remove dispersed oily materials (emulsified oil) and solids impurities from the oily water 109 that is discharged from the GOSP 100 train. As mentioned, the oily water 109 may be separated produced water. In some existing GOSP facilities, a basic design of the WOSEP vessel 114 may be to handle water cuts from the production well(s), for example, less than 10 vol %. Increased (higher) water cut (e.g., greater than 10 vol %) can lead to the WOSEP vessel 114 in some existing GOSP facilities handling excessive volume of water. Such can cause significant reduction of separation efficiency with the water in the WOSEP vessel 114 starved for retention time for complete separation. This increased volume of oily water (emulsified water) if occurring may exceed the WOSEP vessel processing capacity and trigger incomplete oil-water separation, and give poor quality water (crude oil content as offspec) to injection wells.

Typical GOSP operations in crude oil producing treat produced water (emulsified water) in the WOSEP vessel. An injection pump(s) pump the water from the WOSEP vessel to disposal wells. Due to water injectivity problems, injection wells in existing GOSP facilities have been opened for flowback, which showed flowback water contaminated with relatively large amount of emulsified crude in the flowback from the disposal wells. This indicated that crude oil had accumulated in the injection well bottom, which was identified as a cause of injectivity decline.

Typical WOSEP vessel design in existing facilities may handle, for example, the amount of oily water corresponding to a water cut less than 10 vol % of the crude oil from the wellhead to the GOSP. In particular, the basic design of the WOSEP vessel in an existing GOSP may be for water cuts, for example, less than 10 vol %, and thus handle the amount of oily water discharged by the GOSP train to the WOSEP vessel corresponding with the produced crude oil from the wellhead (entering the GOSP) having less than 10 vol % water. However, increasing water cut (e.g., to above design basis) in the wet crude production increases the amount of incoming water to GOSP and thus increases the volume of oily water to the WOSEP vessel. Such may cause (or result in) reduced retention time in the WOSEP vessel and therefore poor quality water (excessive crude oil content) from the WOSEP vessel to disposal wells. An increasing amount of water in wet-crude production can generally lead to the WOSEP vessel accommodating more water and thus having reduced retention time.

Embodiments herein provide for a sand filter in a retrofit of existing GOSP facilities or in new GOSP construction. The filter media be naturally available silica sand, which can be employed at and/or near the WOSP vessel 114 water outlet. The filter media (sand) can be configured as a standalone filter or as a piping spool for installation in GOSP process facilities. The sand filter may remove impurities (crude oil, solids, etc.) present in oily produced water within the GOSP. The sand filter may give filtered water (treated water) quality greater than 99.9 vol % water. As presented in the Example below, this filtration technique was tested at bench scale in the laboratory. Laboratory glassware (separating funnel) was filled with silica for filtering intermediate water. The intermediate water may be labeled as emulsified water having crude oil, or as water with emulsified crude oil. The sample of this intermediate water for testing was collected from a discharge of a WOSEP vessel. The concentration of crude oil in this water sample (filtered in the silica sand in the laboratory) was about 4 vol % (40,000 ppmv). The filtered water (filtrate) in the laboratory approached negligible concentration (less than 10 ppmv) of crude oil in the water.

In general for embodiments of the present techniques, the crude oil-in-water of the oily water 109 to the WOSEP vessel system 108 may range, for example, in the range of 1 vol % to 15 vol % (10,000 ppmv to 150,000 ppmv). The water 112 discharged from the WOSEP vessel system 108 may have crude oil, for example, in the range of 10 ppmv to 20,000 ppmv. As mentioned, it may be desired that crude oil content in the water 112 discharged from the WOSEP vessel system 108 be less than 100 ppmv. Such may be beneficial for disposal, such as in the injection of the water 112 into a subterranean formation.

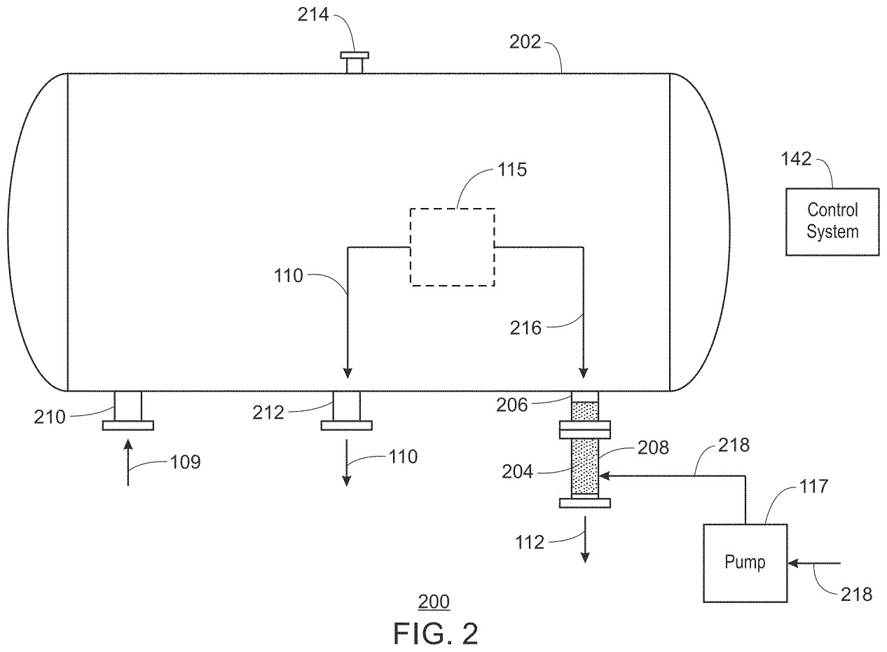

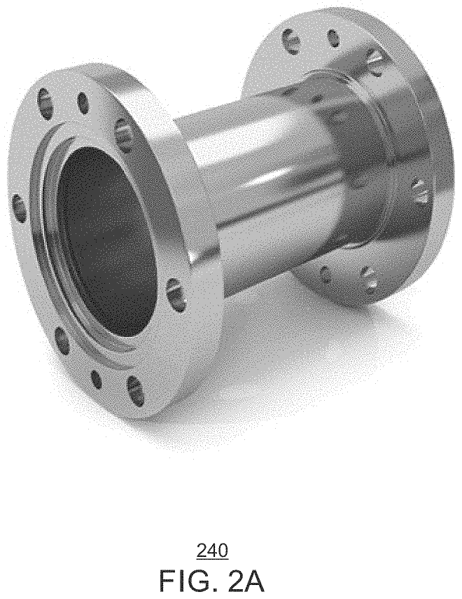

FIG. 2 is a WOSEP vessel system 200 having a WOSEP vessel 202 and a sand filter 204 disposed at the water outlet of the WOSEP vessel 202. The WOSEP vessel system 200, WOSEP vessel 202, and sand filter 204 may be analogous to the WOSEP vessel system 108, WOSEP vessel 114, and sand filter 106, respectively, of FIG. 1.

The sand as filter media (or filter medium) for the sand filter 204 (and 106) and the sand filters discussed with respect to subsequent figures may be natural sand. In other words, in implementations, the sand is not artificial sand, crushed sand, mechanical sand, or synthetic sand. In some regions of the world, natural sand is generally readily available, such as in Saudi Arabia in which silica sand as natural sand is found throughout Saudi Arabia. Silica sand, also known as quartz sand, is silicon dioxide (SiO2). The most common form of SiO2 is quartz, which is a chemically inert and relatively hard mineral. Samples or collections of quartz sand can include other minerals or impurities alongside the silica sand granules.

The WOSEP vessel 202 may have a horizontal orientation (as depicted) or a vertical orientation, and have elliptical-type heads. The WOSEP vessel 202 may be, for example, stainless steel. The WOSEP vessel 202 may have a water outlet nozzle 206 for discharge of intermediate water 216 (first water) that is filtered in the sand filter 206 to give the water 112 (second water) for disposal (e.g., injection) or distribution. The water 112 (second water) may be cleaner than the intermediate water 216 (first water). In implementations, the water 112 that discharges from the sand filter may be labeled as filtrate. The crude oil and any solids that collect on the sand may be labeled as filter cake in certain implementations.

In the illustrated embodiment, the sand filter 204 is sand as filter media disposed at least one of in the water outlet nozzle 206 (of the WOSEP vessel 202) or in the water discharge conduit 208 coupled to the water outlet nozzle 206. If so, the sand filter 204 may be labeled as an inline filter in being installed in the nozzle 206 and/or conduit 208. The filter 208 may include fine-mesh perforated retainer plates or fine-mesh retainer screens to secure the sand in place. In some implementations, the sand filter 204 may extend into the WOSEP vessel 202 at the outlet nozzle 206. For implementations of the sand filter 204 in the nozzle 206 (and optionally into the vessel 202), the sand filter 204 may be considered as a component or vessel internal of the WOSEP vessel 202 in implementations. In embodiments, a flange of the outlet nozzle 206 may be bolted to a flange of the discharge conduit 208, as depicted. The flange connection may provide for access to the sand. A screwed connection or welded connection may be implemented instead of the depicted flanged connection. For the filter 204 as sand (filter media) in the discharge conduit 208, the sand may be in a linear portion (e.g., piping spool piece in FIG. 2A) of the discharge conduit 208, and with this initial linear portion having a flange at each end as depicted. The remaining (downstream) portion of the discharge conduit 208 may couple to the depicted downstream flange of the initial portion or section (e.g., piping spool piece) of the discharge conduit 208. The filter sand (filter media) being in this flanged portion of the discharge conduit 208 may provide for relative ease of access to the sand or sand filter 204.

The WOSEP vessel 202 may have an inlet nozzle 210 for receiving the oily water 109 and an outlet nozzle 212 for discharging the separated crude oil 110. In certain implementations, the separated crude oil 110 may be sent to the LPPT vessel (e.g., 122 in FIG. 1). Thus, the operating pressure of WOSEP vessel 214 may be greater than the LPPT operating pressure.

The WOSEP vessel 202 may have a gas inlet nozzle 214 for introducing a gas (e.g., nitrogen, air, etc.) as a gas pad or gas blanket, which can facilitate pressure control in the WOSEP vessel 202. In one implementation, the gas introduced into the vessel 202 through the gas inlet nozzle 214 may include gas 130 discharged from the HPPT 122 vessel. The WOSEP vessel 202 may include additional nozzles for other inlet and outlet streams, for instrumentation and sensors, and so forth.

The WOSEP vessel 202 may have the internal separator 115 (e.g., a weir or weir arrangement) that separates the crude oil 110 from the oily water 109 and discharges an intermediate water 216 (first water) through the sand filter 204. The intermediate water 216 may be water having crude oil at concentrations of at least 1 vol %, at least 3 vol %, at least 5 vol %, or in a range of 1 vol % to 10 vol %. In implementations, the intermediate water 216 is water having less than 10 vol % of crude oil or less than 5 vol % of crude oil. The sand filter 204 removes crude oil from the intermediate water 216 to give the water 112 (second water) having, for example, less than 1 vol % of crude oil, less than 0.1 vol % of crude oil, less than 100 ppmv of crude oil, or less than 10 ppmv of crude oil. The WOSEP vessel system 200 may include an injection pump 113 (FIG. 1) that injects the water 112 into the subterranean formation. The crude oil removed by the sand filter 204 may collect on the sand in the sand filter 204.

The WOSEP vessel system 200 may include a backwashing pump 117 (e.g., centrifugal pump) that receives backwashing water 218 (e.g., utility water or plant water) via a suction conduit, such as from a water header. The backwashing pump 117 may supply the backwashing water 218 via a discharge supply conduit to the sand filter 204 to backwash the sand filer 204 with the backwashing water 218. The backwashing of the sand filter may clean the sand filter 204 by dislodging the collected crude oil from the sand with the backwashing water 218. The motive force given by the backwashing pump 117 may flow the spent backwashing water 218 (with the crude oil displaced from the sand) from the sand filter 204 into the WOSEP vessel 202 via reverse flow through the outlet nozzle 206. In other implementations, the motive force given by the backwashing pump 117 may flow the spent backwashing water 218 (with the crude oil displaced from the sand) from the sand filter 204 via an outlet (not shown) on the sand filter 204, for example, to sewer or further processing. In general, the backwashing may be implemented intermittently and not continuously.

FIG. 2A is an example of a conduit portion 240 (e.g., spool piece) of the discharge conduit 208 that may couple to the outlet nozzle 206 and house sand as filter media of the sand filter 204. The conduit portion 240 may be longer than depicted. The conduit portion may have an inlet (not shown) for receiving backwashing fluid 218 and an outlet (not shown) for discharge of spent backwashing fluid 218.

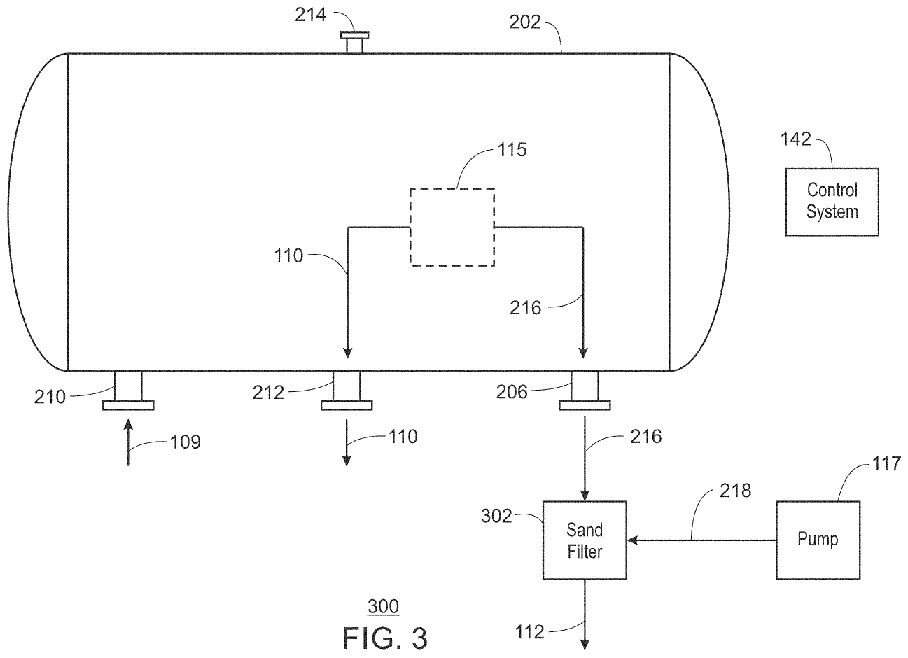

FIG. 3 is a WOSEP vessel system 300 that is similar to the WOSEP vessel system 200 of FIG. 2, except that the sand filter 302 is a standalone filter instead of with the sand (filter media) disposed in the outlet nozzle 206 or in the discharge conduit 208 (FIG. 2). The sand filter 302 may be analogous to the sand filter 106 of FIG. 1. The sand filter 302 may have a vessel (e.g., as the filter 302 housing) with the sand (filter media) disposed in the vessel. The vessel (e.g., filter 302 housing) may be, for example, stainless steel and have a vertical orientation or horizontal orientation. In implementations, the sand filter 302 may be skid-mounted. The sand filter 302 may be disposed along the water discharge conduit from the outlet nozzle 206. The filter 302 housing may have an inlet to receive the intermediate water 216 and an outlet to discharge the water 112 having, for example, less than 1000 ppmv of crude oil or less than 100 ppm of crude oil. The sand filter 302 may discharge the water 112 for injection via a pump (not shown) into a subterranean formation.

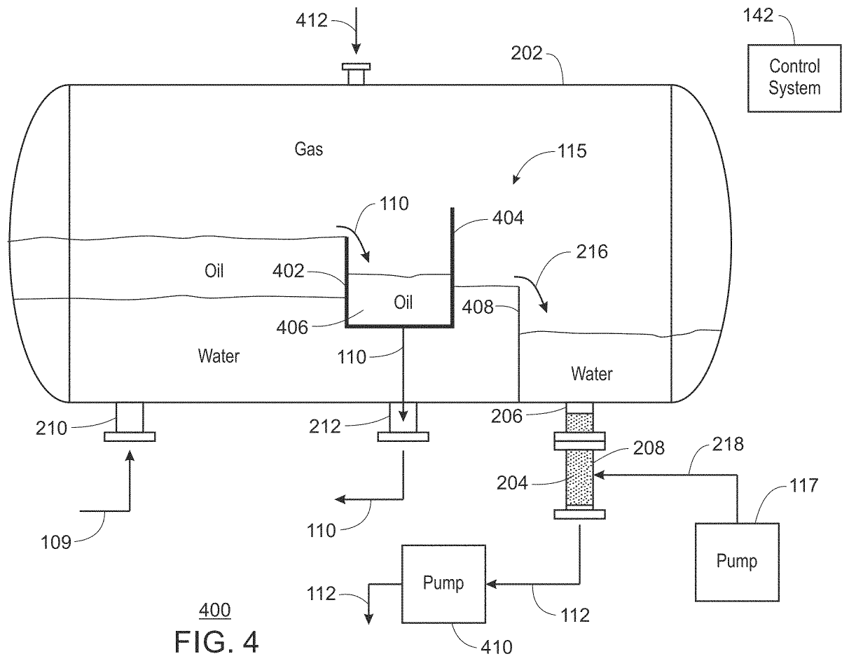

FIG. 4 is a WOSEP vessel system 400 that is similar to the WOSEP vessel system 200 of FIG. 2, except that the internal separator 115 is depicted in particular as a weir or weir arrangement (labeled for this illustrated embodiment as weir or weir arrangement 115). The separation via the weir arrangement 115 may utilize gravity or density difference to separate the crude oil 110 from the intermediate water 216. In other words, the crude oil 110 (the lighter of the two liquids) overflows the oil weir or weir wall 402. The crude oil 110 may discharge from within this weir. The intermediate water 216 (the heavier of the two liquids) may overflow the water weir or weir wall 408.

Thus, the weir arrangement 115 includes an oil weir or oil weir wall 402 (plate) for the crude oil 110. The oil weir wall 402 along with a back wall 404 (plate) and bottom plate form an oil bucket 406 to collect the separator crude oil 110 that flows over the oil weir 402. A conduit internal in the WOSEP vessel 202 conveys the crude oil 110 from the oil bucket 406 to the oil outlet nozzle 212.

The weir or weir arrangement 115 includes the water weir wall 408 (plate) in which the intermediate water 216 overflows for discharge through the water outlet nozzle 206. The intermediate water 216 (e.g., having crude oil in a range of 1 vol % to 10 vol %) flows through the sand filter 206 having sand as filter media situated in the outlet nozzle 206 and/or in the discharge conduit 208. The water 112 (e.g., having crude oil at less than 1000 ppmv, less than 100 ppmv, or less than 30 ppmv) discharges from the sand filter 204 and downstream through the discharge conduit 208. An injection pump 410 (e.g., centrifugal pump) may pump the water 112 to inject the water 112 (e.g., via an injection well) into a subterranean formation.

A gas 412 blanket may be in the vapor space of the WOSEP vessel 202. The gas 412 may be supplied, for example, via an inlet nozzle the WOSEP vessel 202.

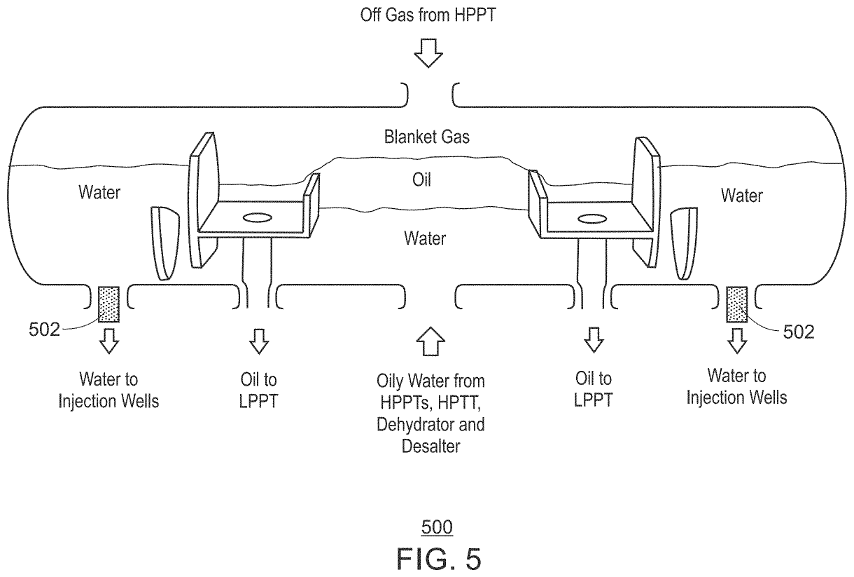

FIG. 5 is a WOSEP vessel 500 having an inlet nozzle for receiving oily water (e.g., 109 in FIG. 1). The WOSEP vessel 500 has an internal weir system to separate crude oil from the oily water. The WOSEP vessel 500 has two oil outlet nozzles for discharge of the separated crude oil (e.g., 210 in FIG. 2). In some implementations, the separated crude oil may be provided to the LPPT vessel (e.g., 128 in FIG. 1) of the GOSP train. In the illustrated implementation, the WOSEP vessel 500 has two water outlet nozzles for discharge of intermediate water (e.g., having crude oil in the range of 1 vol % to 10 vol %), which is the oily water minus the separated crude oil. Sand (e.g., including quartz sand) may be secured (e.g., via support and hold-down screens) in each of the two water outlet nozzles and/or in the respective discharge conduits (not shown) as a respective sand filter 502. In other implementations, each sand filter may be a standalone filter (having a vessel as filter housing with the sand as filter media) disposed along the respective water discharge conduit coupled to the respective water outlet nozzle.

Each sand filter 502 may remove crude oil from the intermediate water discharged from the WOSEP vessel 500 to give cleaner water (e.g., having less than 1 vol % of crude oil or less than 0.01 vol % of crude oil) for disposal (e.g., injection) or recovery. Each sand filter 502 may occasionally (intermittently) be subjected to water backwash to clean (remove collected oil and solids from) the sand filter 502.

A blanket gas may be provide to the WOSEP vessel 500 through a gas inlet nozzle on the WOSEP vessel 500. In operation, the blanket gas may reside in the vapor space of the WOSEP vessel 500. In a particular implementation, the blanket gas is off gas (e.g., a portion of 130 in FIG. 1) from the HPPT vessel of the GOSP train.

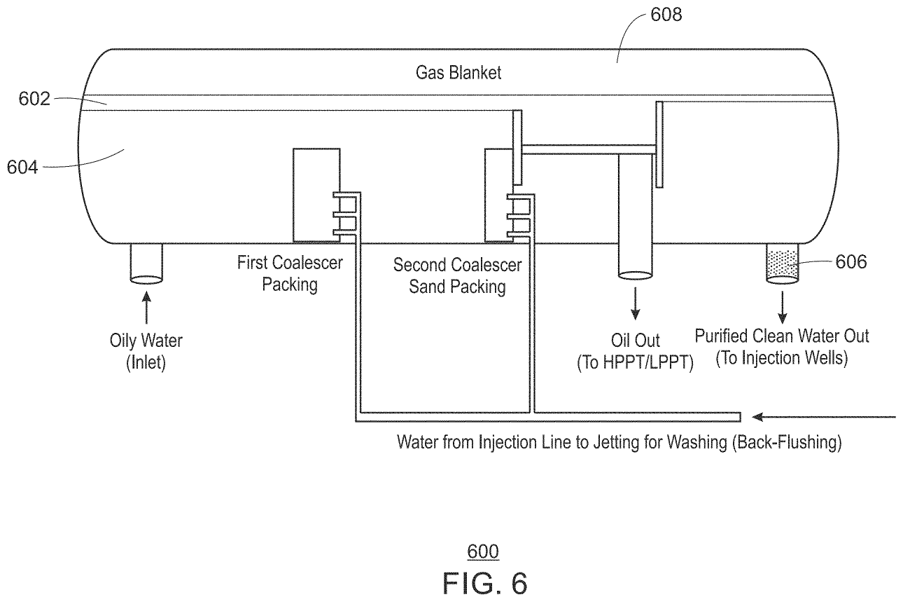

FIG. 6 is a WOSEP vessel 600 having an inlet nozzle for receiving oily water (e.g., 109 in FIG. 1). Due to density differences, the oily water separates into a layer 602 of crude oil and a layer 604 of water. The WOSEP vessel 500 has an internal weir to separate crude oil from the oily water. Crude oil is discharged from an oil bucket of the weir through an oil outlet nozzle of the WOSEP vessel 600. This separated crude oil discharged from the WOSPE vessel 600 may be recovered.

Water as intermediate water (e.g., having crude oil in the range of 1 vol % to 10 vol %) is discharged through a water outlet nozzle of the WOSEP vessel 600. A sand filter 606 may be situated in the water outlet nozzle or in a water discharge conduit coupled to the water outlet nozzle, or in both. In operation, the sand filter 606 removes crude oil from the intermediate water discharged from the WOSP vessel 600 to give water having less than 0.1 vol % crude oil, less than 100 ppmv crude oil, or less than 20 ppmv crude oil. The crude oil removed from the intermediate water by the sand filter 606 may collect on the sand (filter media) in the sand filter 606. The water discharged from the sand filter 606 may be disposed, such as by injection (e.g., via an injection well) into a subterranean formation.

The WOSEP vessel 600 may include at least one coalescer system that is a coalescer filter. The coalescer filter includes a housing vessel with internal packing as a coalescer element. The oily water enters the coalescer filter as water having dispersed oil or as water emulsified with oil. A coalescer (coalescer system or coalescer filter) may separate emulsion substances such as water and oil by relying on coalescence of droplet. This may involve relying on the unification principle of small liquid droplets into larger droplets as the material flows through the coalescer element. Gravity may cause water droplets, which are denser than oil, to precipitate down to the bottom of the coalescer to give separation.

In the illustrated embodiment, the WOSEP vessel 600 has two coalescer filters as internal components in the WOSEP vessel 600. The first coalescer filter has packing. The second coalescer filter has sand (e.g., quartz sand) as packing. Water may be provided to the coalescers for washing (backflushing) the coalescers to clean the packing. The water used for backflushing may discharge from the coalescers into the vessel 600. In some examples, the water supply utilized for backflushing is taken downstream of an injection pump that introduces water discharged from sand filter into an injection well or subterranean formation. The backwashing system for the coalescers may also be employed to backflush the sand filter 602, or a separate independent backwashing system may be utilized to backflush the sand filter 602. Lastly, a gas blanket may be applied to the WOSEP vessel 600 in operation.

The oily water fed to the WOSP vessel 600 may be water having oil dispersed therein or emulsified water (water emulsified with oil). As discussed, a GOSP train may supply the oily water from different stages, such as the HPPT, LPPT, dehydrator, and desalter. The operating pressure in the stages, or pumps (e.g., centrifugal pumps) receiving the oily water from the stages, may provide motive force for flow of the oily water to and through the WOSP vessel 600. The fluid flow inside the WOSP vessel 600 is driven by pressure differential through the vessel, with the pressure at the oily water inlet being greater than the pressure at the oil outlet and water outlet.

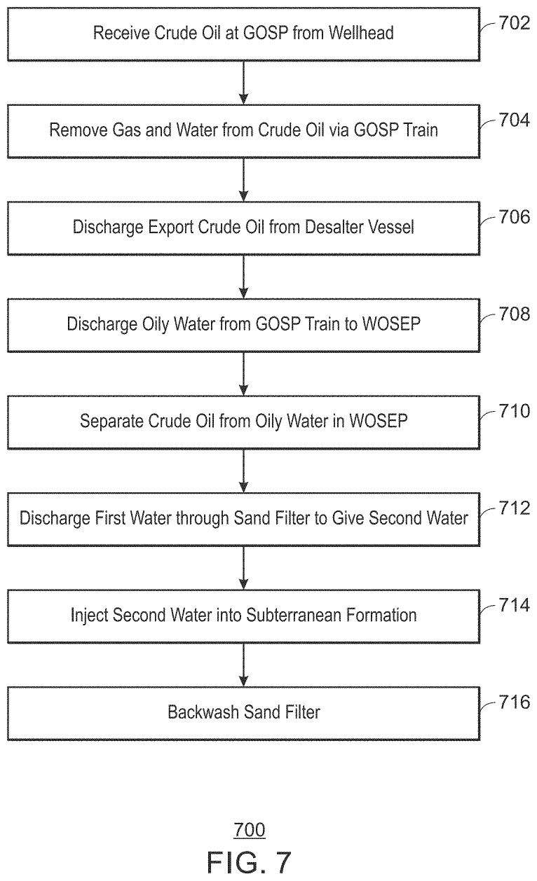

FIG. 7 is a method 700 of operating a GOSP. At block 702, the method includes receiving crude oil at the GOSP from a wellhead. The crude oil received may be an emulsion of crude oil and water. The crude oil may be received at the GOSP through a production manifold from a well. The crude oil received may be as produced from a subterranean formation through a wellbore and wellhead. The crude oil may flow through a production manifold associated with one or more wellheads to the GOSP train. This feed crude oil to the GOSP may be from a well pool.

At block 704, the method includes removing gas, water, and salt (e.g., NaCl) from the crude oil via a GOSP train that includes a first production trap, a second production trap, a dehydrator vessel, and a desalter vessel. The first production trap and the second production trap may operate at sequentially lower pressure to remove gas as volatile gases. In embodiments, the GOSP may include two-stage desalting involving the dehydrator vessel and the desalter vessel.

At block 706, the method includes discharging export crude oil from the desalter vessel. The export crude oil may be crude oil as processed by the GOSP. This export crude oil may be product crude oil of the GOSP. The GOSP may discharge the export crude oil to storage or transportation for distribution. The export (product) crude oil may be routed through a stabilization distillation column in some implementations. The export crude oil may be further processed, such as at a petroleum refinery.

At block 708, the method includes discharging oily water from the GOSP train to a WOSEP vessel in a WOSEP vessel system. The oily water includes water and crude oil. The oily water may have, for example, at least 5 vol % of crude oil. The discharging of the oily water from the GOSP train may involve discharging oily water from at least one of the first production trap or the dehydrator to the WOSEP vessel. The method may also include providing gas from the first production trap to the WOSEP vessel, such as for a gas blanket or gas pad in the WOSEP vessel (e.g., in the vapor space of the WOSEP vessel).

At block 710, the method includes separating crude oil from the oily water via a weir in the WOSEP vessel to give first water (intermediate water). The first water may have, for example, at least 1 vol % of crude oil, The weir may include more than one weir. The weir may include weir plates. The weir may be a weir arrangement or weir system. In implementations, the method may include providing the crude oil removed via the weir to the second production trap.

At block 712, the method includes discharging the first water from the WOSEP vessel through a sand filter of the WOSEP vessel system, thereby removing crude oil from the first water via the sand filter to give second water (e.g., water cleaned for disposal). In implementations, the second water (e.g., for injection disposal) has less than 1 vol % of crude oil, less than 0.1 vol % of crude oil, or less than 0.01 vol % of crude oil. In implementations, the second water is water having crude oil in a range of 0.001 vol % to 0.1 vol %.

The sand filter is a filter having sand as filter media. The sand may be natural sand. The sand may be quartz sand (silica sand). The removing of the crude oil from the first water via the sand filter may involve collecting the crude oil removed from the first water on the sand. The collecting of the crude oil removed from the first water on the sand may involve depositing or adhering the crude oil removed from the first water onto the sand.

The sand filter may be the sand as the filter media disposed in an outlet nozzle of the WOSEP vessel for the first water or in discharge piping coupled to the outlet nozzle, or a combination thereof. Thus, the sand filter may be an in-line sand filter disposed at least one of in a water outlet nozzle of the WOSEP vessel or in water discharge piping coupled to the water outlet nozzle, wherein the water outlet nozzle is for discharge of the first water (intermediate water) from the WOSEP vessel. This water outlet nozzle may be labeled as the first-water outlet nozzle or the intermediate-water outlet nozzle because the water outlet nozzle is for the first water (intermediate water).

At block 714, the method includes injecting the second water (from the sand filter) into a subterranean formation. The second water may have less than 1000 ppmv of crude oil or less than 100 ppmv of crude oil. The injecting of the second water may involve flowing the second water from the sand filter to an injection pump (e.g., centrifugal pump). The injection pump may pump (inject) the second water via an injection well into a subterranean formation for disposal. More than one injection pump may be employed.

At block 716, the method includes backwashing (backflushing) the sand filter, such as with backwashing water, to clean the sand filter including cleaning the filter media (sand) in the sand filter. The cleaning (backwashing) may dislodge collected crude from the sand. A backwashing pump (e.g., centrifugal pump) may feed the backwashing water via a supply conduit to the sand filter. The backwashing pump may receive utility water or plant water for employment as the backwashing water.

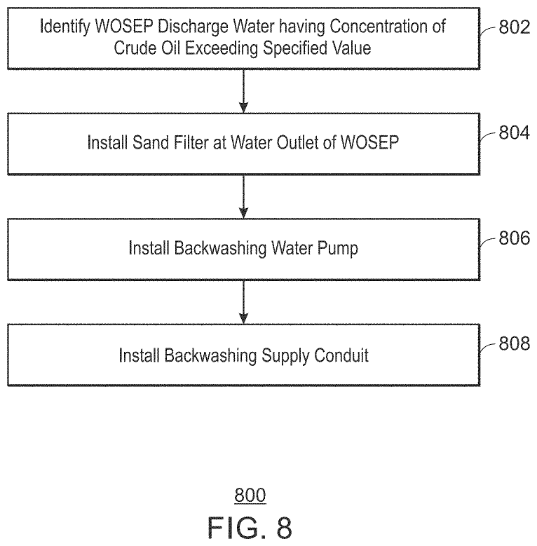

FIG. 8 is a method of retrofitting an existing GOSP that receives crude oil from a wellhead for processing. In some circumstances, a WOSEP vessel in an existing GOSP may underperform leading to high crude-oil content in the water (e.g., for injection disposal) discharged from the WOSEP vessel.

At block 802, the method includes identifying that water discharged from a WOSEP vessel in the GOSP has a concentration of crude oil exceeding a specified value (e.g., 1 vol %). The WOSEP vessel removes crude oil from oily water to give the water. The oily water received at the WOSEP vessel may have, for example, at least 2 vol % of crude oil. The WOSEP vessel may have an internal weir to remove crude oil from the water.

At block 804 the method includes installing a sand filter at a water outlet of the WOSEP vessel, such as in response to the aforementioned concentration of crude oil in the discharged water exceeding the specified value (e.g., 1 vol %). The sand filter is a filter having sand (e.g., quartz sand) as filter media. The flowing the water from the WOSEP vessel through the sand filter may reduce the crude-oil content of the discharged water to less than the specified value.

Installing the sand filter at the water outlet may involve disposing the sand as filter media at least one of in a water outlet of the WOSEP vessel or in a water discharge conduit coupled to the water outlet. Installing the sand filter at the water outlet may involve installing the sand filter along a water discharge conduit from the water-oil separator, and wherein the sand filter includes a vessel (e.g., filter housing) having the sand disposed therein.

The WOSEP vessel in operation receives oily water from a GOSP train of the GOSP, the GOSP train including a first production trap, a second production trap, a dehydrator vessel, and a desalter vessel. The GOSP train in operation removes gas, water, and salt from crude oil received from the wellhead. The crude oil received from the wellhead may be an emulsion of crude oil and water. In operation, the crude oil removed from the oily water via the WOSEP may be provided to the second production trap. In operation, the first production trap may provide gas to the WOSEP vessel.

At block 806, the method includes installing a backwashing water pump. The pump may be, for example, a centrifugal pump. The pump may be installed adjacent or near the sand filter. The backwashing pump may be configured to receive (e.g., via an inlet conduit or suction conduit) utility water or plant water from a water header to be utilized as backwashing water.

At block 808, the method includes installing a backwashing water conduit to supply backwashing water from the discharge of the backwashing water pump to the sand filter. The conduit may tie into the sand filter.

An embodiment is a GOSP. The GOSP has a first production trap that receives crude oil from a wellhead and removes gas and water from the crude oil. The first production trap has an outlet to discharge first oily water to a WOSEP vessel. The GOSP has a second production trap to receive the crude oil from the first production trap and remove gas from the crude oil. The GOSP has a dehydrator vessel that receives the crude oil from the second production trap and removes water from the crude oil. The dehydrator vessel has an outlet to discharge second oily water to the WOSEP vessel.

The GOSP includes the WOSEP vessel to remove crude oil from oily water (including the first oily water and the second oily water) to discharge crude oil and discharge intermediate water. The oily water collectively received at the WOSEP vessel may have, for example, at least 3 vol % of crude oil. The intermediate water discharged from the WOSEP vessel may have, for example, at least 1 vol % crude oil. The GOSP includes a sand filter disposed at an outlet of the WOSEP vessel to remove crude oil from the intermediate water and discharge water having, for example, less than 0.1 vol % of crude oil. The sand filter is a filter having sand as filter media. The sand filter may be an in-line sand filter disposed at least one of in an outlet nozzle of the WOSEP vessel or in a discharge conduit coupled to the outlet nozzle, wherein the outlet nozzle is for discharge of the intermediate water from the WOSEP vessel.

The GOSP may include a backwashing water pump and a backwashing water conduit to supply backwashing water to the sand filter. The GOSP may include an injection pump to inject the water discharged from the sand filter into a subterranean formation. The GOSP may include a desalter vessel to receive the crude oil from the dehydrator vessel and remove water including salt from the crude oil and discharge export crude oil.

Another embodiment is a method of operating a GOSP, the method including receiving crude oil from a wellhead at the GOSP. The method includes removing gas, water, and salt from the crude oil via a GOSP train of the GOSP, the GOSP train having a first production trap, a second production trap, a dehydrator vessel, and a desalter vessel. The method includes discharging oily water from the GOSP train to a water-oil separator vessel, the oily water including water and crude oil. The oily water may be, for example, water having at least 5 vol % of crude oil. The discharging of oily water from the GOSP train may include discharging oily water to the water-oil separator vessel from at least one of the first production trap or the dehydrator vessel. The method includes separating the crude oil from the oily water via a weir in the water-oil separator vessel to give first water. The method may include providing the crude oil removed via the weir to the second production trap. The first water may be, for example, water having at least 1 vol % of crude oil. The method includes discharging the first water from the water-oil separator vessel through a sand filter, thereby removing crude oil from the first water via the sand filter to give second water (e.g., water having less than 1 vol % of crude oil). The sand filter is a filter having sand (e.g., natural sand) as filter media. The sand may be quartz sand that is silica sand. The removing of crude oil from the first water via the sand filter may involve collecting the crude oil removed from the first water on the sand. The method may include backwashing the sand filter with water. The sand filter may include the sand as the filter media disposed at least one of in an outlet nozzle of the water-oil separator vessel for the first water or in discharge piping coupled to the outlet nozzle. The sand filter may be an in-line sand filter disposed at least one of in a water outlet nozzle of the water-oil separator vessel or in water discharge piping coupled to the water outlet nozzle, wherein the water outlet nozzle is for discharge of the first water from the water-oil separation vessel. The method may include injecting the second water into a subterranean formation. The method may include discharging export crude oil from the desalter vessel. The method may include providing gas from the first production trap to the water-oil separator vessel.

Yet another embodiment is method of retrofitting a GOSP, including identifying that water discharged from a water-oil separator vessel in the GOSP has a concentration of crude oil exceeding a specified value (e.g., 1 vol %). The water-oil separator vessel removes crude oil from oily water to give the water. The water-oil separator vessel have a weir to remove the crude oil from the water. The water-oil separator vessel in operation receives the oily water (e.g., water having at least 2 vol % of crude oil) from a GOSP train of the GOSP. The method includes installing a sand filter at a water outlet of the water-oil separator vessel. The sand filter is a filter having sand (e.g., quartz sand) as filter media. The GOSP train includes a first production trap, a second production trap, a dehydrator vessel, and a desalter vessel. The GOSP train in operation removes gas, water, and salt from crude oil received from a wellhead. The crude oil received from the wellhead may be an emulsion of crude oil and water. The method includes installing a backwashing water pump. The method includes installing a backwashing water conduit to supply backwashing water from the backwashing water pump to the sand filter. The installing of the sand filter at the water outlet may involve disposing the sand as filter media at least one of in a water outlet of the water-oil separator vessel or in a water discharge conduit coupled to the water outlet. The installing of the sand filter at the water outlet may involve installing the sand filter along a water discharge conduit from the water-oil separator vessel, wherein the sand filter is a vessel having the sand disposed therein. The crude oil removed from the oily water via the water-oil separator vessel may be provided to the second production trap. The first production trap may gas to the water-oil separator vessel.

### Example

The Example is given as an example and not meant to limit the present techniques. Silica sand (quartz sand) was locally collected as natural sand for the Example. An emulsion of water (about 96 vol %) and crude oil (about 4 vol %) was collected as the water discharge from a WOSEP vessel in the field in a GOSP.

In the Example, two identical experiments were performed in the laboratory. The same experiment procedure was utilized for each experiment.

Experiment procedure: The silica sand was placed in a separating funnel (glass) in the laboratory. The funnel bottom was plugged with a small pinch of cotton. The emulsion of water (about 96 vol %) and crude oil (about 4 vol %) was introduced into the top of the funnel and filtered through the silica sand as filter media. The funnel was placed in a stand, allowing for the emulsion to flow down through the sand by gravity. The clean water that discharged from the funnel bottom was collected over time. The clean water that discharged from the funnel bottom was measured for concentration of crude oil. The concentration of crude oil in the clean water as measure by visible spectroscopy was less than 0.01 vol % in both the first experiment and the second (identical) experiment.

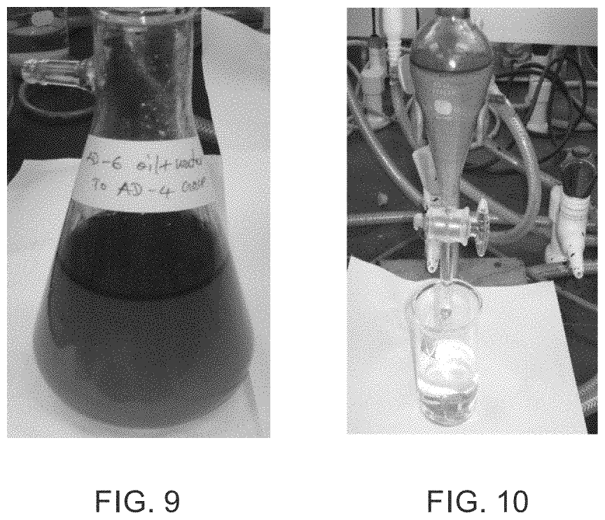

FIG. 9 is a beaker having the emulsion of water (about 96 vol %) and crude oil (about 4 vol %) utilized in the Example. As mentioned, the emulsion of water was introduced into funnel at the top of the funnel, and was filtered by the silica sand in the funnel to give the clean water discharged from the bottom of the funnel.

FIG. 10 depicts the filtration performed in the experiment procedure in the Example. The separating funnel has the silica sand therein as filter media, and with the emulsion (which introduced at the top of the funnel) flowing by gravity downward through the sand. The clean water is discharging from the funnel bottom into a beaker. As can be seen in the image of FIG. 10, the clean water in the beaker is clear.

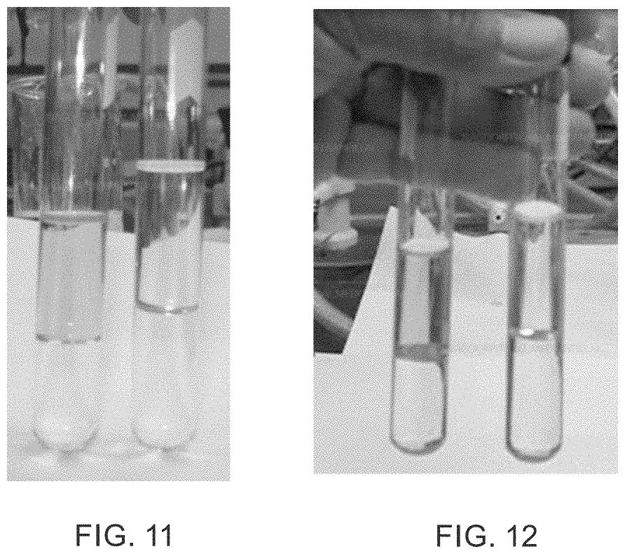

FIG. 11 is two test tubes from the first experiment in the Example. The test tube on the left has the emulsion of water (about 96 vol %) and crude oil (about 4 vol %) collected from the water discharge of the WOSEP vessel in the field. The test tube on the right has the clean water (filtered water) discharged after filtering the emulsion through the sand.

FIG. 12 is two test tubes from the second experiment in the Example. The test tube on the left has the emulsion of water (about 96 vol %) and crude oil (about 4 vol %) collected from the water discharge of the WOSEP vessel in the field. The test tube on the right has the clean water (filtered water) discharged after filtering the emulsion through the sand.

A number of implementations have been described. Nevertheless, it will be understood that various modifications may be made without departing from the spirit and scope of the disclosure.

What is claimed is:

1. A method of operating a gas oil separation plant (GOSP), the method comprising:
receiving crude oil from a wellhead;
removing gas, water, and salt from the crude oil via a GOSP train comprising a first production trap, a second production trap, a dehydrator vessel, and a desalter vessel;
discharging oily water from the GOSP train to a water-oil separator vessel, the oily water comprising water and crude oil;
separating the crude oil from the oily water via a weir in the water-oil separator vessel to give first water; and
discharging the first water from the water-oil separator vessel through a sand filter, thereby removing crude oil from the first water via the sand filter to give second water, wherein the sand filter is a filter having sand as filter media.

2. The method of claim 1, wherein discharging oily water from the GOSP train comprises discharging oily water from at least one of the first production trap or the dehydrator vessel to the water-oil separator vessel, wherein removing crude oil from the first water via the sand filter comprises collecting the crude oil removed from the first water on the sand, and wherein the sand comprises natural sand.

3. The method of claim 1, wherein the sand filter comprises an in-line sand filter disposed at least one of in a water outlet nozzle of the water-oil separator vessel or in water discharge piping coupled to the water outlet nozzle, wherein the water outlet nozzle is for discharge of the first water from the water-oil separation vessel, and wherein the sand comprises quartz sand comprising silica sand.

4. The method of claim 1, wherein the sand as the filter media is disposed at least one of in an outlet nozzle of the water-oil separator vessel for the first water or in discharge piping coupled to the outlet nozzle, wherein the oily water comprises at least 5 vol % of crude oil, wherein the first water comprises at least 1 vol % of crude oil, and wherein the second water comprises less than 1 vol % of crude oil.

5. The method of claim 1, comprising:
injecting the second water into a subterranean formation; and
discharging export crude oil from the desalter vessel.

6. The method of claim 1, comprising providing the crude oil removed via the weir to the second production trap.

7. The method of claim 1, comprising backwashing the sand filter with water.

8. The method of claim 1, comprising providing gas from the first production trap to the water-oil separator vessel.

9. A method of retrofitting a gas oil separation plant (GOSP), the method comprising:
identifying that water discharged from a water-oil separator vessel in the GOSP comprises a concentration of crude oil exceeding a specified value, wherein the water-oil separator vessel removes crude oil from oily water to give the water;
installing a sand filter at a water outlet of the water-oil separator vessel, wherein the water-oil separator vessel in operation receives oily water from a GOSP train of the GOSP, the GOSP train comprising a first production trap, a second production trap, a dehydrator vessel, and a desalter vessel, and wherein the GOSP train in operation removes gas, water, and salt from crude oil received from a wellhead;
installing a backwashing water pump; and
installing a backwashing water conduit to supply backwashing water from the backwashing water pump to the sand filter, wherein the sand filter is a filter having sand as filter media.

10. The method of claim 9, wherein the crude oil received from the wellhead comprises an emulsion of crude oil and water, wherein the water-oil separator vessel comprises a weir to remove the crude oil from the water, and wherein the sand comprises quartz sand.

11. The method of claim 9, wherein installing the sand filter at the water outlet comprises disposing the sand as filter media at least one of in a water outlet of the water-oil separator vessel or in a water discharge conduit coupled to the water outlet.

12. The method of claim 9, wherein installing the sand filter at the water outlet comprises installing the sand filter along a water discharge conduit from the water-oil separator vessel, and wherein the sand filter comprises a vessel having the sand disposed therein.

13. The method of claim 9, wherein the crude oil removed from the oily water via the water-oil separator vessel is provided to the second production trap, and wherein the first production trap provides gas to the water-oil separator vessel.

14. The method of claim 9, wherein oily water comprises at least 2 volume percent (vol %) of crude oil, and wherein the specified value is 0.1 vol %.

15. A gas oil separation plant (GOSP) comprising:
a first production trap to receive crude oil from a wellhead and remove gas and water from the crude oil, the first production trap comprising an outlet to discharge first oily water to a water-oil separator vessel;
a second production trap to receive the crude oil from the first production trap and remove gas from the crude oil;
a dehydrator vessel to receive the crude oil from the second production trap and remove water from the crude oil, the dehydrator vessel comprising an outlet to discharge second oily water to the water-oil separator vessel;
the water-oil separator vessel to remove crude oil from oily water comprising the first oily water and the second oily water to discharge crude oil and discharge intermediate water; and
a sand filter disposed at an outlet of the water-oil separator vessel to remove crude oil from the intermediate water and discharge water, wherein the sand filter is a filter having sand as filter media.

16. The GOSP of claim 15, wherein the oily water comprises at least 3 vol % of crude oil, wherein the intermediate water comprises at least 1 vol % crude oil, and wherein the water discharged from the sand filter comprises less than 0.1 vol % of crude oil.

17. The GOSP of claim 15, wherein the sand filter comprises an in-line sand filter disposed in an outlet nozzle of the water-oil separator vessel or in a discharge conduit coupled to the outlet nozzle, or a combination thereof, and wherein the outlet nozzle is for discharge of the intermediate water from the water-oil separator vessel.

18. The GOSP of claim 15, comprising a backwashing water pump and a backwashing water conduit to supply backwashing water to the sand filter.

19. The GOSP of claim 15, comprising an injection pump to inject the water discharged from the sand filter into a subterranean formation.

20. The GOSP of claim 15, comprising a desalter vessel to receive the crude oil from the dehydrator vessel and remove water comprising salt from the crude oil and discharge export crude oil.
